(19) United States
(12) Patent Application Publication
(10) Pub. No.: US 2024/0169574 A1
(43) Pub. Date: May 23, 2024

(54) MOBILE BODY, INFORMATION PROCESSING METHOD, AND PROGRAM

(71) Applicant: SONY GROUP CORPORATION, TOKYO (JP)

(72) Inventors: KOHEI URUSHIDO, TOKYO (JP); MASAKI HANDA, TOKYO (JP); TAKUTO MOTOYAMA, TOKYO (JP); SHINICHIRO ABE, TOKYO (JP); MASAHIKO TOYOSHI, TOKYO (JP)

(21) Appl. No.: 18/261,850

(22) PCT Filed: Dec. 21, 2021
(86) PCT No.: PCT/JP2021/047184

§ 371 Date: Jul. 18, 2023

(30) Foreign Application Priority Data
Jan. 27, 2021 (JP) 2021-011219

(51) Int. Cl. G06T 7/593; G06T 5/40; G06T 7/12; G06T 7/70; G06T 7/80; G06V 10/25

(52) U.S. Cl. CPC G06T 7/593; G06T 5/40; G06T 7/12; G06T 7/70; G06T 7/80; G06V 10/25

(57) ABSTRACT

A mobile body (1) includes an image slide unit (11), a parallax histogram aggregation unit (13), and a miscalibration detection unit (14). The image slide unit (11) generates a slide image (SLI) obtained by sliding a first viewpoint image (VPI1) in a parallax direction. The parallax histogram aggregation unit (13) generates a parallax histogram (HG) from the slide image (SLI) and a second viewpoint image (VPI2). The miscalibration detection unit (14) determines that the miscalibration has occurred when a lower boundary value of the parallax on the histogram (HG) is smaller than the slide amount of the first viewpoint image (VPI1).

### FIELD

The present invention relates to a mobile body, information processing method, and a program.

### BACKGROUND

There is known a technique of detecting an object from an image captured by a stereo camera attached to a mobile body such as a car.

### CITATION LIST

### Patent Literature

Patent Literature 1: JP 2018-025906 A

### SUMMARY

### Technical Problem

The stereo camera includes a plurality of imaging units for capturing images from different viewpoints. The distance (baseline length) between the imaging units is adjusted by calibration. However, there is a possibility of occurrence of misalignment (hereinafter, referred to as miscalibration) in a relative position between the imaging units due to vibration during movement. The movement performed with miscalibration would lead to a failure in correct recognition of the surrounding environment. This leads to unstable movement in some cases.

In view of this, the present disclosure proposes a mobile body, an information processing method, and a program capable of detecting miscalibration.

### Solution to Problem

According to the present disclosure, a mobile body is provided that comprises: an image slide unit that generates a slide image by sliding a first viewpoint image in a parallax direction; a parallax histogram aggregation unit that generates a parallax histogram from the slide image and a second viewpoint image; and a miscalibration detection unit that determines an occurrence of miscalibration when a lower boundary value of the parallax in the histogram is smaller than a slide amount of the first viewpoint image. According to the present disclosure, an information processing method in which an information process of the mobile body is executed by a computer, and a program for causing the computer to execute the information process of the mobile body, are provided.

### BRIEF DESCRIPTION OF DRAWINGS

FIG. 1 is a schematic diagram of a stereo camera.

FIG. 2 is a diagram illustrating a depth estimation method.

FIG. 3 is a diagram illustrating a relationship between depth and parallax.

FIG. 4 is a diagram illustrating a first influence of miscalibration.

FIG. 5 is a diagram illustrating the first influence of miscalibration.

FIG. 6 is a diagram illustrating the first influence of miscalibration.

FIG. 7 is a diagram illustrating a second influence of miscalibration.

FIG. 8 is a diagram illustrating the second influence of miscalibration.

FIG. 9 is a diagram illustrating a miscalibration detection method.

FIG. 10 is a diagram illustrating a miscalibration detection method.

FIG. 11 is a diagram illustrating a miscalibration detection method.

FIG. 12 is a diagram illustrating a configuration of a mobile body of a first embodiment.

FIG. 13 is a flowchart illustrating an example of information processing performed by a processing device.

FIG. 14 is a diagram illustrating a configuration of a mobile body of a second embodiment.

FIG. 15 is a diagram illustrating an example of a subject area.

FIG. 16 is a diagram illustrating a configuration of a mobile body of a third embodiment.

FIG. 17 is a diagram illustrating an example of a subject area.

FIG. 18 is a diagram illustrating another example of a method of selecting a stereo camera.

FIG. 19 is a diagram illustrating another example of a method of selecting the stereo camera.

FIG. 20 is a diagram illustrating an example of information processing based on a movement history.

FIG. 21 is a diagram illustrating an example of information processing based on an environmental map.

FIG. 22 is a diagram illustrating an example in which a moving speed is restricted as abnormality handling processing.

FIG. 23 is a diagram illustrating an example in which notification to the user is performed as the abnormality handling processing.

FIG. 24 is a diagram illustrating another example of notification.

FIG. 25 is a diagram illustrating another example of notification.

FIG. 26 is a diagram illustrating a hardware configuration example of a processing device.

FIG. 27 is a diagram illustrating another example for avoiding the second influence of miscalibration.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Note that the description will be given in the following order.
[1. Overview]
[1-1. Distance estimation using stereo camera]
[1-2. Influence of miscalibration of stereo camera 1]
[1-3. Influence of miscalibration of stereo camera 2]
[1-4. Miscalibration detection method]
[1-4-1. Expansion of search area]
[1-4-2. Verification processing using parallax histogram]
2. First Embodiment
[2-1. Configuration of mobile body]
[2-2. Information processing method]
[2-3. Effects]
3. Second Embodiment
[3-1. Configuration of mobile body]
[3-2. Effects]
4. Third Embodiment
[4-1. Configuration of mobile body]
[4-2. Information processing method 1]
[4-3. Information processing method 2]
[4-4. Effects]
[5. Abnormality handling processing]
[5-1. Restriction of moving speed]
[5-2. Notification to user]
[5-3. Automatic calibration]
[5-4. Depth correction]
[6. Hardware configuration example]
[7. Modification]

### 1. Overview

### [1-1. Distance Estimation Using Stereo Camera]

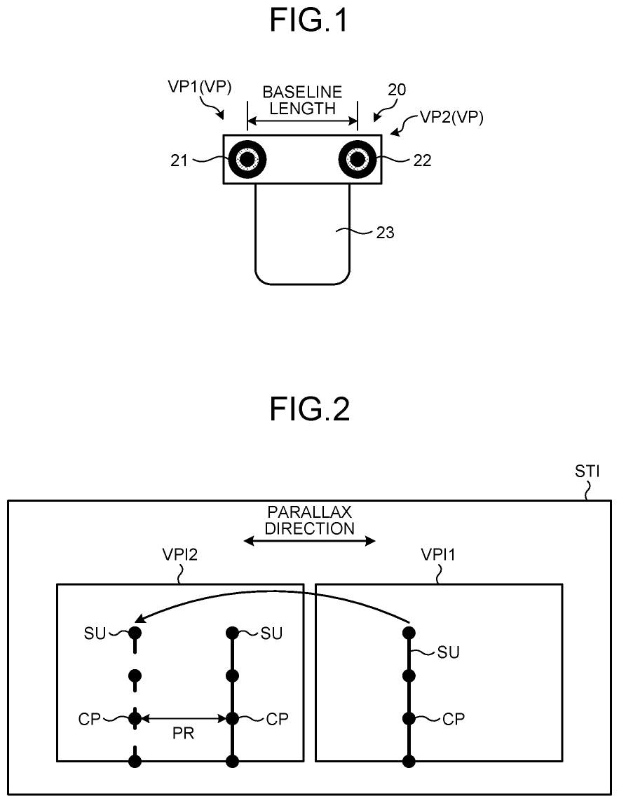

FIG. 1 is a schematic diagram of a stereo camera 20.

The stereo camera 20 includes a first imaging unit 21 and a second imaging unit 22. The stereo camera 20 is attached to a lower portion of a mobile body such as a drone via a support member 23, for example. The first imaging unit 21 and the second imaging unit 22 are disposed at positions (viewpoints VP) separated by a predetermined distance (baseline length). A direction connecting the first imaging unit 21 and the second imaging unit 22 is a parallax direction in which parallax occurs. The distance to the object (hereinafter, referred to as a “depth”) is estimated using a method such as triangulation on the basis of the parallax of the object viewed from the first imaging unit 21 and the second imaging unit 22.

FIG. 2 is a diagram illustrating a depth estimation method.

The stereo camera 20 simultaneously captures a subject SU from two viewpoints VP using the first imaging unit 21 and the second imaging unit 22. This leads to image capturing of a stereo image STI including the first viewpoint image VPI1 and the second viewpoint image VPI2. The first viewpoint image VPI1 is an image obtained by capturing the subject SU from the first viewpoint VP1 by the first imaging unit 21. The second viewpoint image VPI2 is an image obtained by capturing the subject SU from the second viewpoint VP2 by the second imaging unit 22.

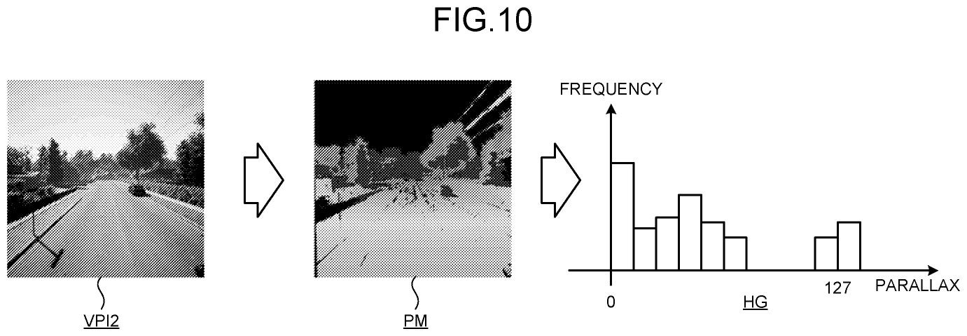

The stereo camera 20 associates the first viewpoint image VPI1 and the second viewpoint image VPI2 for each pixel by stereo matching, for example. The stereo camera 20 calculates a distance between corresponding points CP when the first viewpoint image VPI1 is projected on the second viewpoint image VPI2, as a parallax PR. The stereo camera 20 generates a parallax map PM (refer to FIG. 10) in which information of the parallax PR is associated with each pixel of the second viewpoint image VPI2. The stereo camera 20 calculates a depth DP for each pixel by the triangulation method using the parallax map PM and the baseline length information.

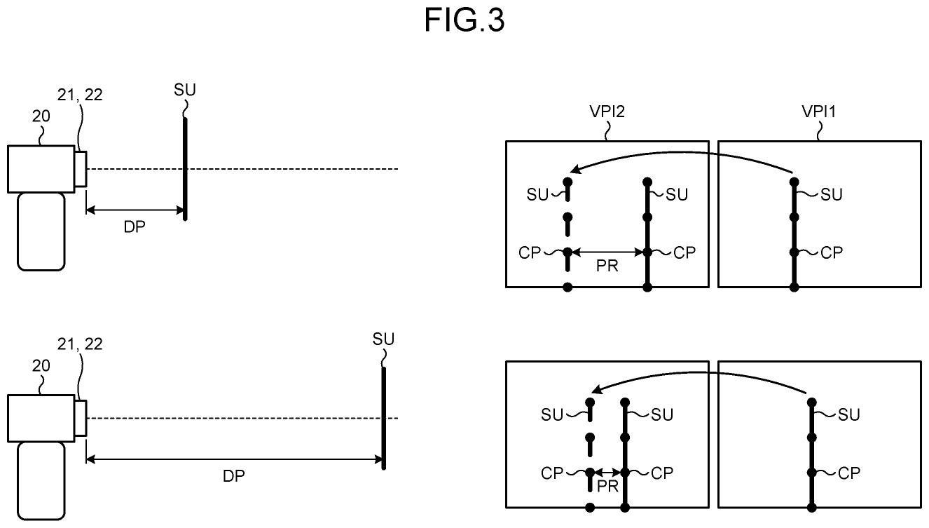

FIG. 3 is a diagram illustrating a relationship between the depth DP and the parallax PR.

The upper part of FIG. 3 illustrates an example in which the distance between the subject SU and the stereo camera 20 is short. The subject SU is captured at a position closer to the end with respect to the center of the visual field of each imaging unit. Accordingly, the parallax PR is large. The lower part of FIG. 3 illustrates an example in which the distance between the subject SU and the stereo camera 20 is long. The subject SU is captured at a position close to the center of the visual field of each imaging unit. Accordingly, the parallax PR is small. In this manner, the depth DP and the parallax PR have a negative correlation. The smaller the depth DP, the larger the parallax PR; the greater the depth DP, the smaller the parallax PR.

### [1-2. Influence of Miscalibration of Stereo Camera 1]

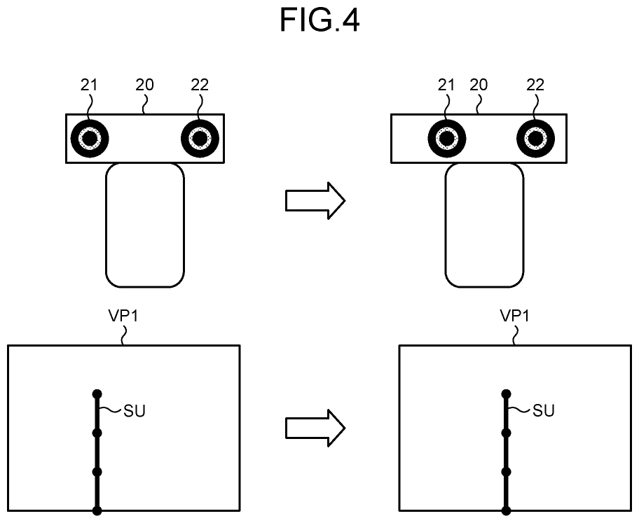

FIGS. 4 to 6 are diagrams illustrating a first influence of miscalibration of the stereo camera 20.

The example on the left side of FIG. 4 illustrates a state in which the first imaging unit 21 and the second imaging unit 22 are fixed at normal positions. The baseline length between the first imaging unit 21 and the second imaging unit 22 does not change from the value set by calibration.

The example on the right side of FIG. 4 illustrates a state in which miscalibration occurs between the first imaging unit 21 and the second imaging unit 22. The position of the first imaging unit 21 is shifted in a direction approaching the second imaging unit 22. Since the world viewed by the first imaging unit 21 is shifted to the side of the second imaging unit 22, the position of the subject SU in the first viewpoint image VPI1 is shifted to the side of the second imaging unit 22 as compared with the normal state.

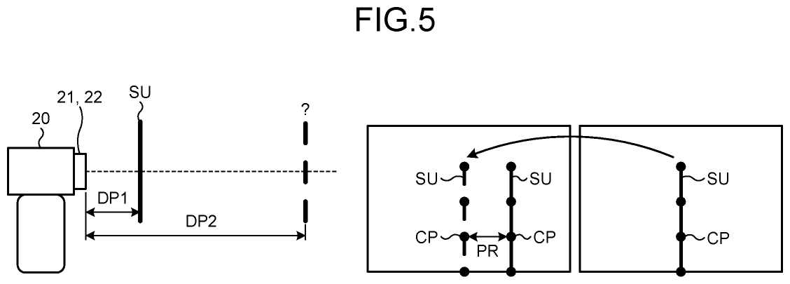

As illustrated in FIG. 5, when the parallax PR between the corresponding points is calculated in a state where the first viewpoint image VPI1 is projected onto the second viewpoint image VPI2, a value smaller than the normal time is obtained by the calculation. Furthermore, the baseline length is smaller than the value set by the calibration. Accordingly, a depth DP2 up to the subject SU is greater than a depth DP1 calculated from the stereo image STI at the normal time.

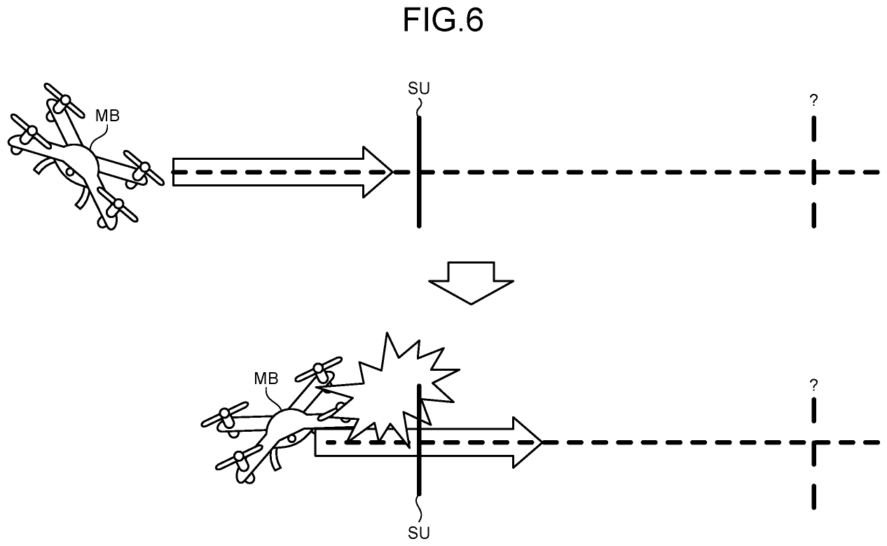

The miscalibration occurs due to various reasons such as heat and shock. Without the capability of detecting occurrence of miscalibration, it is not possible to distinguish whether the subject SU is viewed in a distant position due to the miscalibration or whether the subject SU really exists in the distant position. As illustrated in FIG. 6, in a case where the mobile body MB moving at a high speed has erroneously detected that the distance to the obstacle (subject SU) in the traveling direction is longer than the true distance, there is a possibility of collision even when the mobile body MB recognizes the obstacle. For example, while the mobile body MB attempts to stop when approaching the obstacle, since there is an obstacle at a closer distance than a recognized distance, there is a possibility that the mobile body MB cannot stop in time and hits the obstacle.

### [1-3. Influence of Miscalibration of Stereo Camera 2]

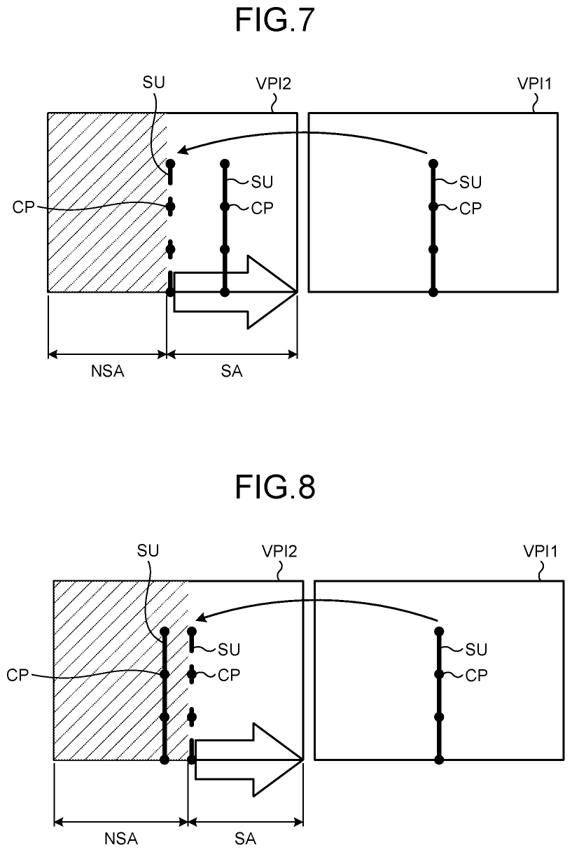

FIGS. 7 and 8 are diagrams illustrating a second influence of the miscalibration of the stereo camera 20.

As illustrated in FIG. 7, in calculation of the parallax PR, the corresponding points CP are searched by matching processing. For example, it is assumed that the first imaging unit 21 is a right camera that captures the subject SU from the right side and that the second imaging unit 22 is a left camera that captures the subject SU from the left side. In this case, when the first viewpoint image VPI1 is projected on the second viewpoint image VPI2, the subject SU appearing in the first viewpoint image VPI1 is always positioned on the left side of the subject SU appearing in the second viewpoint image VPI2. In order to reduce the calculation load in the matching processing, the search for the corresponding point CP is selectively performed in a search area SA having a predetermined width on the right side of the position of the subject SU appearing in the first viewpoint image VPI1.

An area other than the search area SA is defined as a non-search area NSA. The search for the corresponding point CP is not performed in the non-search area NSA. The width of the search area SA (the number of pixels in the parallax direction in which the search is performed) is set in consideration of the estimation accuracy of the depth and the load of the calculation. In the following description, the width of the search area SA is set to 127 pixels, for example.

As illustrated in FIG. 4, when the position of the first imaging unit 21 is shifted to the left side (the second imaging unit 22 side), the position of the subject SU appearing in the first viewpoint image VPI1 is shifted to the right side. As illustrated in FIG. 8, when the position of the subject SU appearing in the first viewpoint image VPI1 is set on the right side of the position of the subject SU appearing in the second viewpoint image VPI2, the corresponding point CP of the second viewpoint image VPI2 is to be positioned in the non-search area NSA, leading to a failure of the search for the corresponding point CP.

### [1-4. Miscalibration Detection Method]

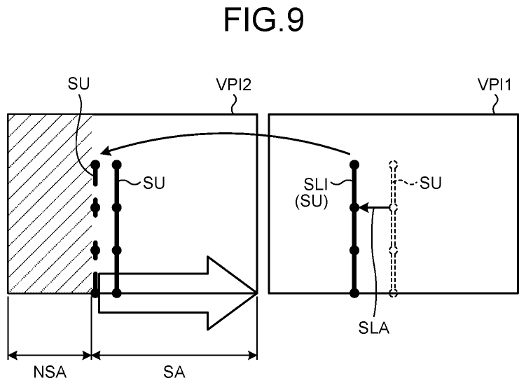

FIGS. 9 to 11 are diagrams illustrating a miscalibration detection method. The detection of the miscalibration is implemented by expansion of the search area SA using a slide image SLI and by verification processing using a parallax histogram.

### [1-4-1. Expansion of Search Area]

FIG. 9 is a diagram illustrating a method of expanding the search area SA.

As described above, miscalibration leads to misalignment of the relative positions of the first viewpoint image VPI1 and the second viewpoint image VPI2, having a possibility of causing a failure in the search for the corresponding point CP. To handle this, the present disclosure uses a method in which the position of the subject SU appearing in the first viewpoint image VPI1 is slid by a preset slide amount SLA in a direction of increasing the parallax PR (the left side in the example of FIG. 9). This allows the slide image SLI in which the position of the subject SU has been slid to be projected on the second viewpoint image VPI2. The corresponding point CP is searched between the slide image SLI and the second viewpoint image VPI2. With this configuration, the search area SA is expanded by the slide amount SLA. Therefore, the search for the corresponding point CP is unlikely to fail even with occurrence of miscalibration.

The slide amount SLA is represented by the number of pixels in the second viewpoint image VPI2, for example. The slide amount SLA is set in a range of two pixels or more and ten pixels or less, for example. In the following description, the slide amount SLA is set to six pixels, for example.

### [1-4-2. Verification Processing Using Parallax Histogram]

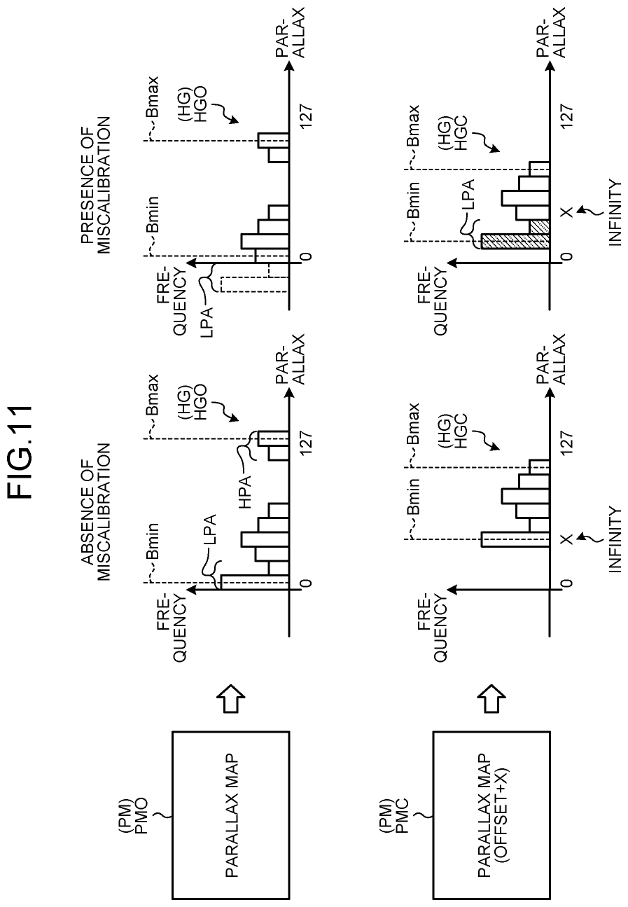

FIGS. 10 and 11 are diagrams illustrating miscalibration verification processing using a parallax histogram.

As described above, the slide image SLI obtained by sliding the first viewpoint image VPI in the parallax direction is projected on the second viewpoint image VPI2. As illustrated in FIG. 10, the parallax map PM is generated by calculating the parallax PR between the second viewpoint image VPI and the slide image SLI for each pixel. The parallax map PM is generated by associating the value of the parallax PR with each pixel of the second viewpoint image VPI2. FIG. 10 illustrates a parallax map PM in which the magnitude of the parallax PR of each pixel is expressed by color.

The histogram HG of the parallax PR is generated on the basis of the parallax map PM. The image area of the parallax map PM to be aggregated can be set by the user. In the present embodiment, for example, the data of the parallax PR of all the pixels in the parallax map PM is aggregated.

As illustrated in FIG. 11, the distribution of the histogram HG varies depending on the slide amount SLA. For example, the upper part of FIG. 11 illustrates an example in which the slide amount SLA is 0 (reference example of not performing the slide processing), and the lower part of FIG. 11 illustrates an example in which the slide amount SLA is X. In the example in the lower part of FIG. 11, the distribution of the histogram HG slides in the parallax direction by the slide amount SLA. Along with the variation of the search area SA, the value of a lower boundary value Bmin, which is the lower limit value of the parallax PR, and the value of an upper boundary value Bmax, which is the upper limit value of the parallax PR, also vary.

The lower boundary value Bmin represents the minimum parallax PR having a significant frequency. The upper boundary value Bmax represents the maximum parallax PR having a significant frequency. Whether the value has a significant frequency is determined on the basis of a preset criterion. For example, in a case where the frequency is so low as to be considered as noise (for example, the frequency is 5 or less), it is determined that the value has no significant frequency.

For example, in the example in the upper part of FIG. 11, the lower boundary value Bmin is 0 and the upper boundary value Bmax is 127 in the case of no occurrence of miscalibration (the left side in the upper part of FIG. 11). As illustrated in FIG. 4, when the visual field FV of the first imaging unit 21 is shifted to the left side, the distribution of the histogram HG is obtained as a distribution in which the distribution with no occurrence of miscalibration is shifted in the negative direction (refer to the upper right side of FIG. 11). Since the corresponding point CP is not searched in the direction in which the parallax PR is negative (non-search area NSA), the distribution of a low parallax area LPA, in which the parallax PR appearing at no occurrence of miscalibration is near zero, is not reflected on the histogram HG.

In the lower example of FIG. 11, the histogram HG is generated using the slide image SLI. Therefore, the distribution of the histogram HG is to be shifted in the positive direction by the slide amount SLA as a whole as compared with the case where no miscalibration occurs (refer to the lower left side of FIG. 11). As a result, the lower boundary value Bmin of the histogram HG is X. Since the corresponding point CP is not searched in the direction in which the parallax PR is greater than 127 (non-search area NSA), the distribution of a high parallax area HPA, in which the parallax PR appearing at no occurrence of miscalibration is near 127, is not reflected on the histogram HG.

In the example in the lower part of FIG. 11, when the miscalibration as illustrated in FIG. 4 occurs, the distribution of the histogram HG is obtained as a distribution in which the distribution with no occurrence of miscalibration is shifted in the negative direction (refer to the right side of the lower part of FIG. 11). Since the lower boundary value Bmin is shifted in the positive direction by the slide processing, the distribution of the low parallax areas LPA is likely to be reflected on the histogram HG.

As illustrated in the lower left part of FIG. 11, in the case of no occurrence of miscalibration, the lower boundary value Bmin matches the slide amount SLA. As illustrated in the lower right part of FIG. 11, with the occurrence of miscalibration, the lower boundary value Bmin is shifted to the negative side due to the miscalibration. Therefore, the lower boundary value Bmin does not match the slide amount SLA. Therefore, by comparing the lower boundary value Bmin with the slide amount, it is possible to determine whether the miscalibration has occurred. Hereinafter, a configuration of a mobile body adopting the above-described miscalibration detection method will be described.

### 2. First Embodiment

### [2-1. Configuration of Mobile Body]

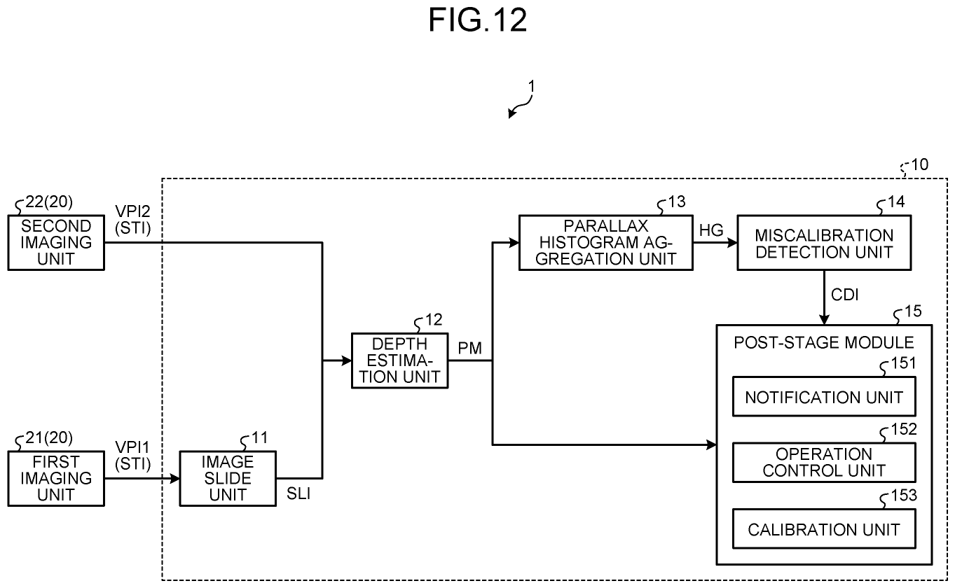

FIG. 12 is a diagram illustrating a configuration of a mobile body 1 of the first embodiment.

The mobile body 1 includes a processing device 10 and a stereo camera 20. The processing device 10 is an information processing device that processes various types of information on the basis of a stereo image STI captured by the stereo camera 20. The stereo image STI includes a first viewpoint image VPI1 captured from the first viewpoint VP1 by the first imaging unit 21 and a second viewpoint image VPI2 captured from the second viewpoint VP2 by the second imaging unit 22. The number of stereo cameras 20 is any number. In the present embodiment, a plurality of stereo cameras 20 having different visual fields is mounted on the mobile body 1, for example.

The processing device 10 includes an image slide unit 11, a depth estimation unit 12, a parallax histogram aggregation unit 13, miscalibration detection unit 14, and a post-stage module 15.

The image slide unit 11 generates a slide image SLI obtained by sliding the first viewpoint image VPI1 in the parallax direction. The slide direction is a direction in which the parallax PR increases when calculating the parallax PR in a state where the slide image SLI is projected onto the second viewpoint image VPI2. The slide amount SLA is preset by the user. In the present embodiment, for example, the slide amount SLA is set to six pixels.

The depth estimation unit 12 generates the parallax map PM using the slide image SLI and the second viewpoint image VPI2. For example, the depth estimation unit 12 projects the slide image SLI onto the second viewpoint image VPI2 and calculates the distance between the corresponding points CP as the parallax PR. The depth estimation unit 12 calculates the parallax PR for all the pixels of the second viewpoint image VPI2, and generates the parallax map PM in which information regarding the parallax PR is associated with each pixel of the second viewpoint image VPI2.

The parallax map PM is used in the processing of generating the histogram HG for detecting the miscalibration. In a case where no miscalibration occurs, the depth estimation unit 12 acquires both the first viewpoint image VPI1 and the second viewpoint image VPI2 from the stereo camera 20, and estimates the depth of the subject SU for each pixel on the basis of the first viewpoint image VPI1 and the second viewpoint image VPI2. Alternatively, the depth estimation unit 12 may correct the parallax map PM on the basis of the slide amount SLA, and estimate the depth of the subject SU for each pixel on the basis of the corrected parallax map PM.

The parallax histogram aggregation unit 13 generates the histogram HG of the parallax PR from the slide image SLI and the second viewpoint image VPI2. For example, the parallax histogram aggregation unit 13 calculates the frequency (the number of pixels) for each parallax PR on the basis of the parallax map PM. This leads to generation of the histogram HG indicating the distribution of the frequency of the parallax PR.

The miscalibration detection unit 14 determines that the miscalibration has occurred when the lower boundary value Bmin of the parallax PR on the histogram HG is smaller than the slide amount SLA of the first viewpoint image VPI1. The miscalibration detection unit 14 outputs detection information CDI indicating occurrence of miscalibration to the post-stage module 15.

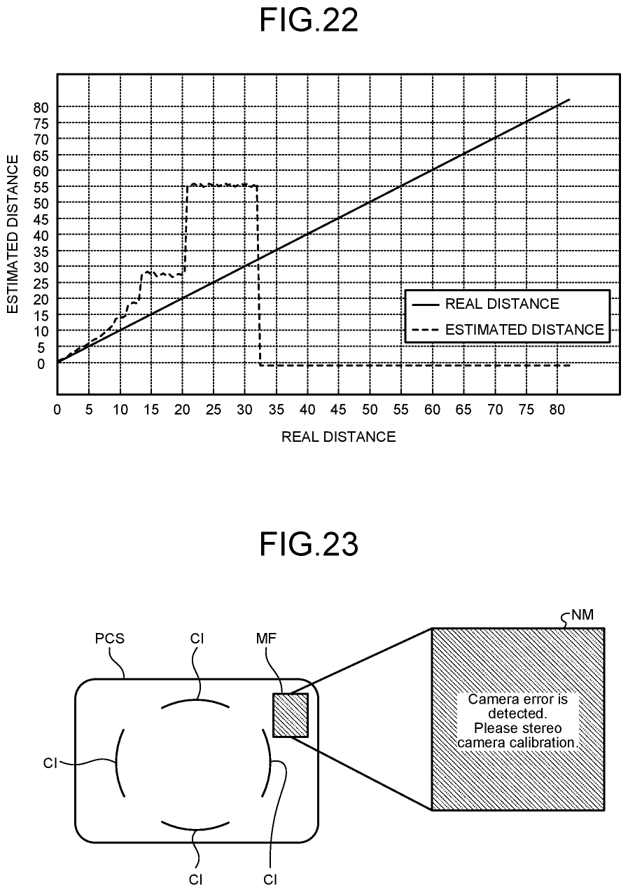

The post-stage module 15 performs abnormality handling processing on the basis of the detection information CDI. The post-stage module 15 includes various configurations according to the type of the abnormality handling processing, such as a notification unit 151, an operation control unit 152, and a calibration unit 153. These functions will be described with reference to FIG. 22 and subsequent drawings.

### [2-2. Information Processing Method]

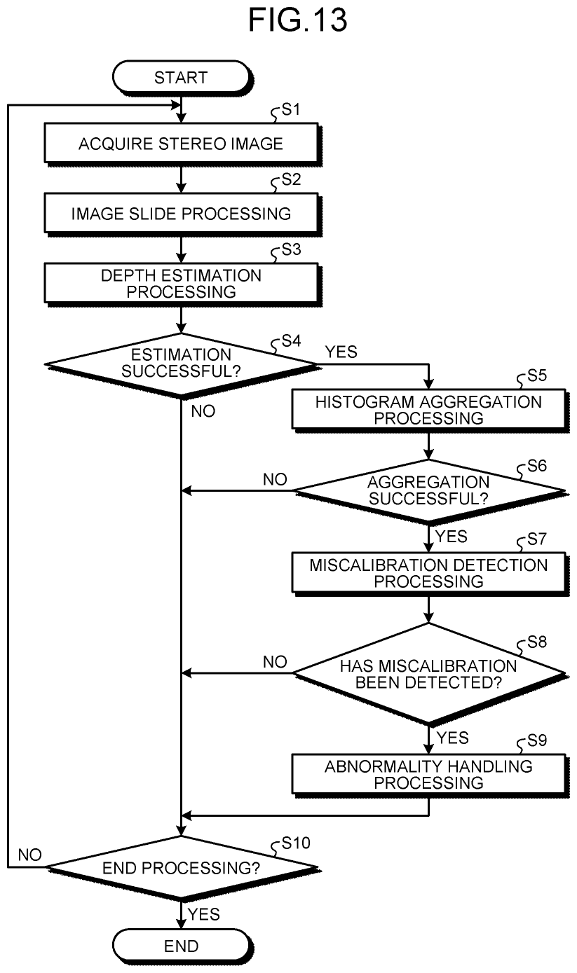

FIG. 13 is a flowchart illustrating an example of information processing performed by the processing device 10.

In step S1, the processing device 10 acquires the stereo image STI including the first viewpoint image VPI1 and the second viewpoint image VPI2 from the stereo camera 20. The first viewpoint image VPI1 is supplied to the image slide unit 11. The second viewpoint image VPI2 is supplied to the depth estimation unit 12.

In step S2, the image slide unit 11 generates the slide image SLI obtained by sliding the first viewpoint image VPI1 in the parallax direction. The image slide unit 11 supplies the generated slide image SLI to the depth estimation unit 12.

In step S3, the depth estimation unit 12 performs depth estimation processing using the second viewpoint image VPI2 and the slide image SLI. In step S4, the depth estimation unit 12 determines whether the depth can be successfully estimated. For example, in a case where there is a defect such as blown-out highlights or occlusion in the stereo image STI (second viewpoint image VPI2), the depth estimation unit 12 determines that the depth cannot be successfully estimated. With no defect in the stereo image STI, the depth estimation unit 12 determines that the depth can be successfully estimated.

In a case where it is determined in step S4 that the depth has been successfully estimated (step S4: Yes), the processing proceeds to step S5. In step S5, the parallax histogram aggregation unit 13 generates the histogram HG of the parallax PR on the basis of the parallax map PM. In step S6, the parallax histogram aggregation unit 13 determines whether the histogram HG has been successfully aggregated.

For example, the parallax histogram aggregation unit 13 acquires information regarding the search result of the corresponding point CP from the depth estimation unit 12. As described above, the depth estimation unit 12 uses stereo matching to search for the corresponding point CP between the slide image SLI and the second viewpoint image VPI2. The depth estimation unit 12 determines that the parallax PR has been successfully detected when the corresponding point CP exists in the search area SA, and determines that the parallax PR has not been successfully detected when the corresponding point CP does not exist in the search area SA.

When information indicating successful search of the corresponding point CP is acquired from the depth estimation unit 12, the parallax histogram aggregation unit 13 determines that the histogram HG has been successfully aggregated. When the parallax histogram aggregation unit 13 acquires information indicating failure of the search for the corresponding point CP from the depth estimation unit 12, it is determined that the histogram HG has not been successfully aggregated.

In a case where it is determined in step S6 that the histogram HG has been successfully aggregated (step S6: Yes), the processing proceeds to step S7. In step S7, the miscalibration detection unit 14 performs miscalibration detection processing.

In step S8, the miscalibration detection unit 14 determines whether the miscalibration has been detected on the basis of the lower boundary value Bmin of the histogram HG. For example, when the lower boundary value Bmin is smaller than the slide amount SLA of the first viewpoint image VPI1, the miscalibration detection unit 14 determines that the miscalibration has been detected. When the lower boundary value Bmin is equal to or larger than the slide amount SLA of the first viewpoint image VPI1, the miscalibration detection unit 14 determines whether the miscalibration has been detected is unknown.

In a case where it is determined in step S8 that the miscalibration has been detected (step S8: Yes), the processing proceeds to step S9. In step S9, the post-stage module 15 performs abnormality handling processing.

In a case where it is determined in step S4 that the depth cannot be successfully estimated (step S4: No), in a case where it is determined in step S6 that the histogram HG cannot be successfully aggregated (step S6: No), and in a case where it is determined in step S8 that whether miscalibration has been detected is unknown (step S8: No), the processing proceeds to step S10. In step S10, the processing device 10 determines whether to end the processing. For example, in a case where an end signal is received from the user, the processing device 10 determines to end the processing. When the determination is not to end the processing, the processing returns to step S1, and the above-described processing is repeated until an end signal is received.

### [2-3. Effects]

The mobile body 1 includes the image slide unit 11, the parallax histogram aggregation unit 13, and the miscalibration detection unit 14. The image slide unit 11 generates a slide image SLI obtained by sliding the first viewpoint image VPI1 in the parallax direction. The parallax histogram aggregation unit 13 generates the histogram HG of the parallax PR from the slide image SLI and the second viewpoint image VPI2. The miscalibration detection unit 14 determines that the miscalibration has occurred when the lower boundary value Bmin of the parallax PR on the histogram HG is smaller than the slide amount SLA of the first viewpoint image VPI1. The information processing method of the present embodiment includes execution of processing of the mobile body 1 described above by a computer. The program of the present embodiment causes the computer to implement the processing of the mobile body described above.

With this configuration, the value of the parallax PR in the histogram HG is raised by the slide amount SLA as a whole. With no occurrence of miscalibration, the parallax PR is always equal to or larger than the slide amount SLA. Therefore, by comparing the lower boundary value Bmin of the parallax PR with the slide amount SLA, it is easily detected whether or not miscalibration has occurred.

### 3. Second Embodiment

### [3-1. Configuration of Mobile Body]

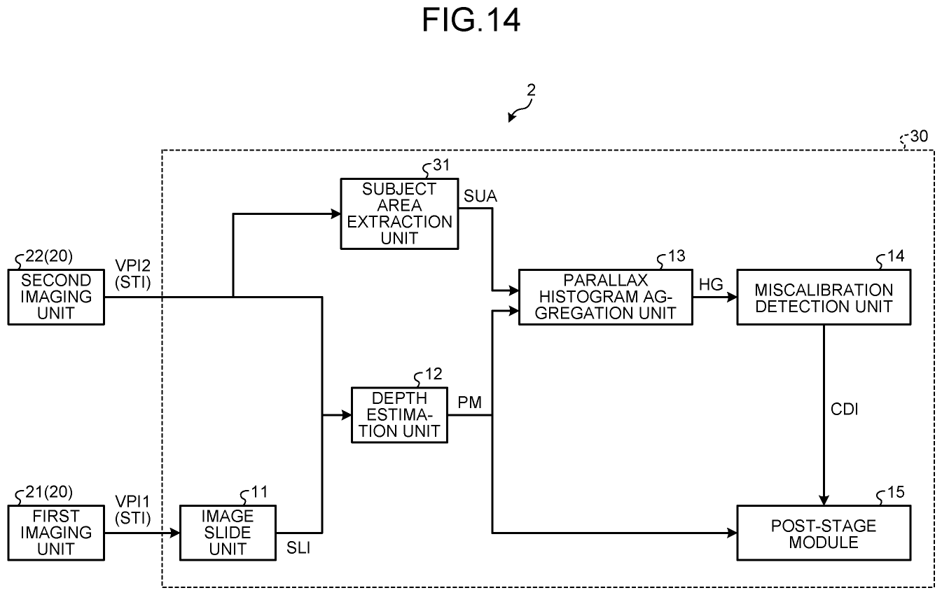

FIG. 14 is a diagram illustrating a configuration of a mobile body 2 according to a second embodiment.

The present embodiment is different from the first embodiment in that the histogram HG is selectively generated for an image area in which miscalibration is expected to be easily detected. Hereinafter, differences from the first embodiment will be mainly described.

A processing device 30 includes a subject area extraction unit 31. The subject area extraction unit 31 extracts a subject area SUA in which the parallax PR is predictable from the second viewpoint image VPI2. The parallax histogram aggregation unit 13 selectively generates the histogram HG for the subject area SUA.

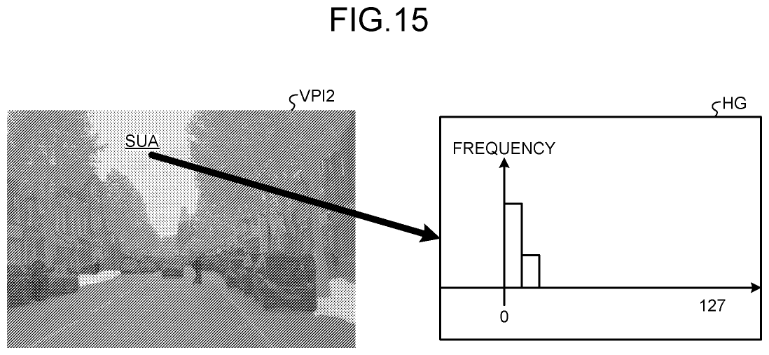

FIG. 15 is a diagram illustrating an example of the subject area SUA.

The subject area SUA is, for example, an image area including the subject SU is so distant from the stereo camera 20 that the parallax PR can be regarded as 0. In the example of FIG. 15, the subject area extraction unit 31 extracts a sky area as the subject area SUA from the second viewpoint image VPI2. The subject area SUA is extracted using a semantic segmentation method which is one of object recognition methods, for example.

The distance to the sky can be regarded infinite. Therefore, the parallax PR of the sky area can be regarded as zero. With no occurrence of miscalibration, the lower boundary value Bmin of the parallax PR in the histogram HG matches the slide amount SLA. When the lower boundary value Bmin of the parallax PR is smaller than the slide amount SLA, it can be determined that the miscalibration has occurred.

### [3-2. Effects]

In the present embodiment, the histogram HG is selectively generated for the specific subject area SUA extracted from the stereo image STI. This reduces the load of calculation at the time of generating the histogram HG. Since the histogram of the area other than the subject area SUA is not included as the noise component, making it possible to suppress erroneous determination.

### 4. Third Embodiment

### [4-1. Configuration of Mobile Body]

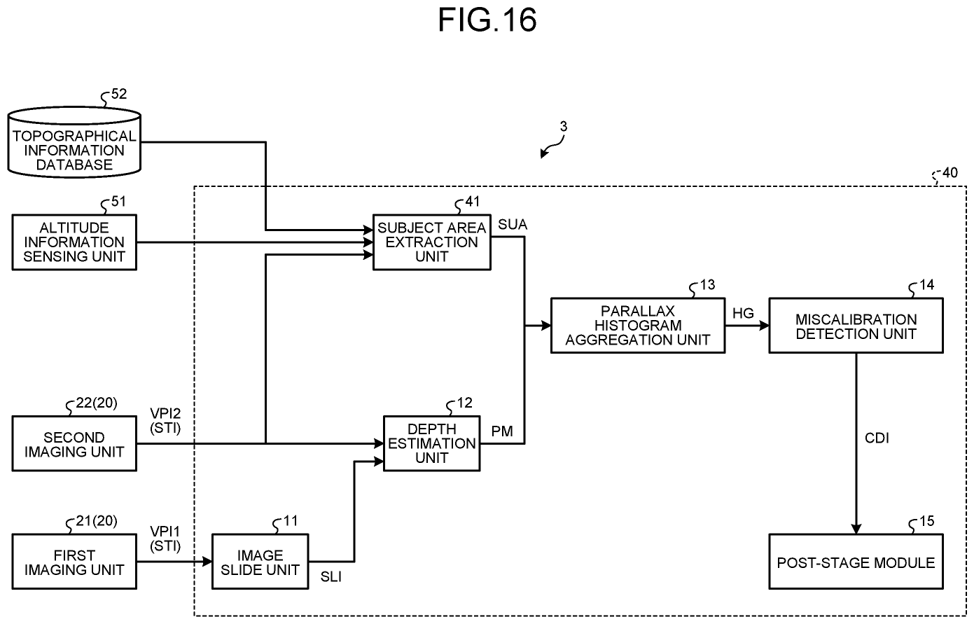

FIG. 16 is a diagram illustrating a configuration of a mobile body 3 of a third embodiment.

The present embodiment is different from the second embodiment in that a subject area extraction unit 41 detects a direction having an expanded visibility, and extracts an area including a distant view visible in the same direction as the subject area SUA. Hereinafter, differences from the second embodiment will be mainly described.

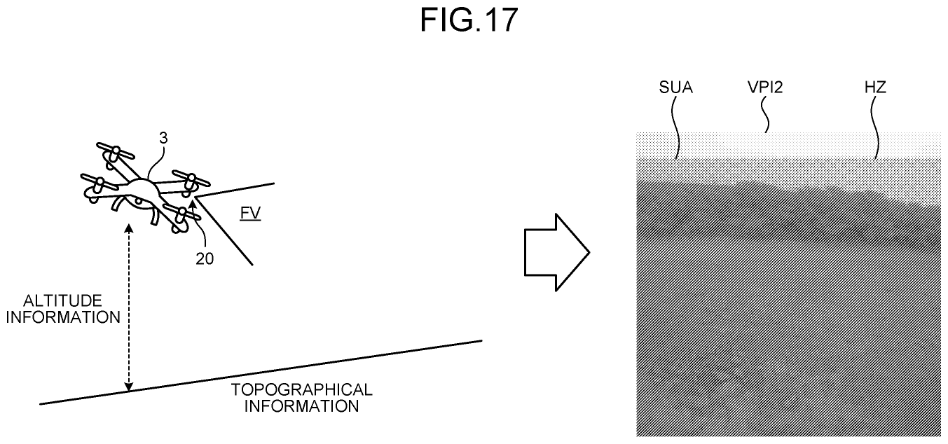

The subject area extraction unit 41 detects the direction in which the horizon HZ (refer to FIG. 17) is visible on the basis of the altitude and geographic information regarding the mobile body 3, for example. The subject area extraction unit 41 selects one or more stereo cameras 20 having the visual field FV in a direction in which the horizon HZ is visible from among the plurality of stereo cameras 20 mounted on the mobile body 3. The subject area extraction unit 41 extracts an area including the horizon HZ as the subject area SUA from the images of the selected one or more stereo cameras 20 on the basis of the altitude and geographical information regarding the mobile body 3.

The distance to the horizon HZ can be regarded as substantially infinite. Accordingly, the parallax PR of the image area where the horizon HZ appears can be regarded as zero. In a case with no occurrence of miscalibration, the lower boundary value Bmin of the parallax PR in the histogram HG matches the slide amount SLA. When the lower boundary value Bmin of the parallax PR is smaller than the slide amount SLA, it can be determined that the miscalibration has occurred.

For example, a processing device 40 includes an altitude information sensing unit 51 and a topographical information database 52. The altitude information sensing unit 51 detects information regarding the altitude of the mobile body 3. Examples of the altitude information sensing unit 51 include a barometric altimeter and a radio altimeter. The topographical information database 52 stores topographical information in which a three-dimensional shape of a ground surface or a building is associated with a geographical position. The topographical information is generated using basic map information of the Geospatial Information Authority of Japan, for example. The subject area extraction unit 41 extracts the subject area SUA on the basis of the altitude information acquired from the altitude information sensing unit 51 and the topographical information acquired from the topographical information database 52.

FIG. 17 is a diagram illustrating an example the subject area SUA.

The mobile body 3 selects the stereo camera 20 having the visual field FV in the direction of the horizon HZ on the basis of the altitude information and the topographical information. Using the semantic segmentation method, the subject area extraction unit 41 extracts an image area including the horizon HZ as the subject area SUA from the video (second viewpoint image VPI2) of the selected stereo camera 20.

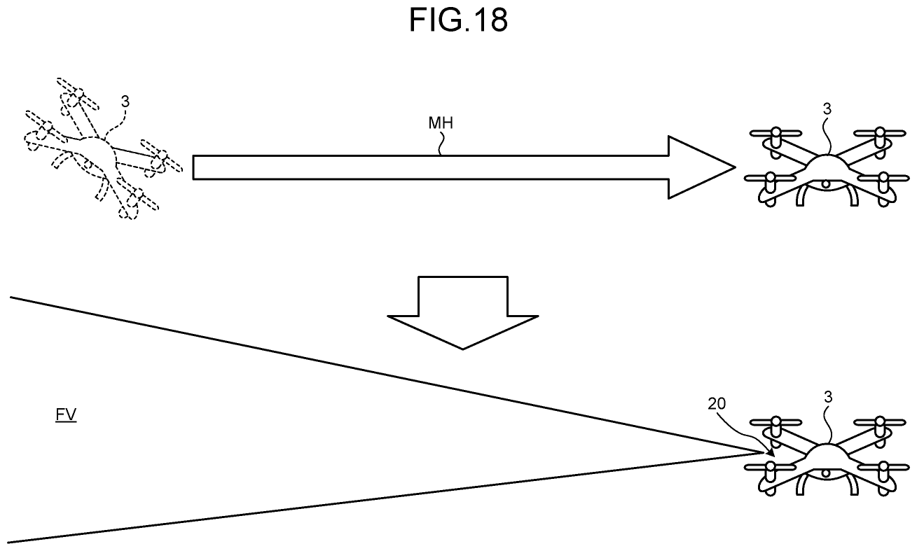

FIG. 18 is a diagram illustrating another example of a method of selecting the stereo camera 20.

In the example of FIG. 18, the stereo camera 20 is selected on the basis of a movement history MH of the mobile body 3. For example, the subject area extraction unit 41 detects the movement history MH using a known method such as simultaneous localization and mapping (SLAM). The subject area extraction unit 41 determines the direction in which the mobile body 3 has moved on the basis of the movement history MH. The subject area extraction unit 41 selects the stereo camera 20 having the visual field FV in the direction in which the mobile body 3 has moved. The subject area extraction unit 41 extracts, as the subject area SUA, an area including an image in a direction in which the mobile body 3 has moved in the image of the selected stereo camera 20.

The direction in which the mobile body 3 has moved is estimated to have a high visibility space with few objects blocking the field of view. The stereo camera 20 is estimated to have an image of a distant scene. The distance to a distant scene can be regarded as substantially infinite. Therefore, the parallax PR of the area including a distant scene can be regarded as zero. In a case with no occurrence of miscalibration, the lower boundary value Bmin of the parallax PR in the histogram HG matches the slide amount SLA. When the lower boundary value Bmin of the parallax PR is smaller than the slide amount SLA, it can be determined that the miscalibration has occurred.

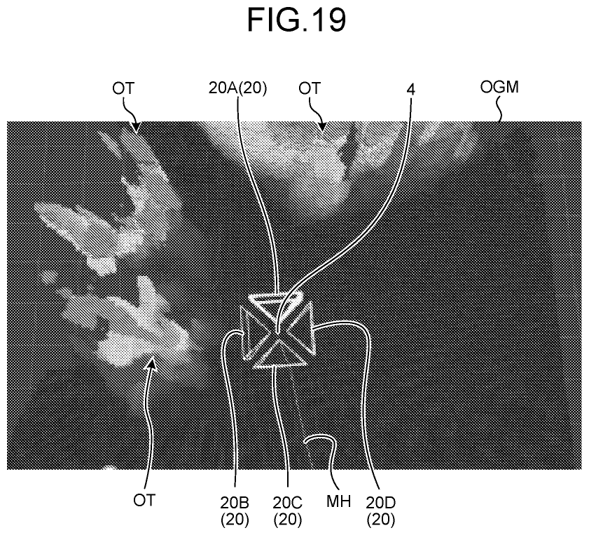

FIG. 19 is a diagram illustrating another example of the method of selecting the stereo camera 20.

In the example of FIG. 19, the subject area extraction unit 41 determines a direction having few objects OT blocking the field of view on the basis of an environmental map OGM and position information of the mobile body 3. The subject area extraction unit 41 selects the stereo camera 20 having the visual field FV in a direction having few objects OT blocking the visual field. The subject area extraction unit 41 extracts, as the subject area SUA, an area including an image in a direction having few objects OT blocking the field of view in the image of the selected stereo camera 20.

The environmental map OGM is a map describing information of the surrounding environment. The present embodiment uses an occupancy grid map as the environmental map OGM, for example. The occupancy grid map is a type of measurement map that stores distance and directions between points. On the occupancy grid map, the environment is divided into a plurality of grids, and an existence probability of the object OT is stored for each grid. The subject area extraction unit 41 generates the environmental map OGM using a known method such as SLAM.

In the example of FIG. 19, four stereo cameras 20 are mounted on the mobile body 3. With reference to the moving direction, there are large objects OT blocking the boundary in the front and left directions. Accordingly, it is highly possible that the objects OT block the view of a front stereo camera 20A and a left stereo camera 20B. On the other hand, the rear side is a direction in which the mobile body 3 has moved, having open space with few objects OT blocking the view. According to the environmental map OGM, there is also an open space in the right direction having less objects OT blocking the view. This leads to a low possibility that the objects OT block the view of a rear stereo camera 20C and a right stereo camera 20D.

It is estimated that a distant scene is captured in the image of the stereo camera 20 having the visual field FV in the direction having few objects OT blocking the view. The distance to a distant scene can be regarded as substantially infinite. Therefore, the parallax PR of the area including a distant scene can be regarded as zero. In a case with no occurrence of miscalibration, the lower boundary value Bmin of the parallax PR in the histogram HG matches the slide amount SLA. When the lower boundary value Bmin of the parallax PR is smaller than the slide amount SLA, it can be determined that the miscalibration has occurred.

### [4-2. Information Processing Method 1]

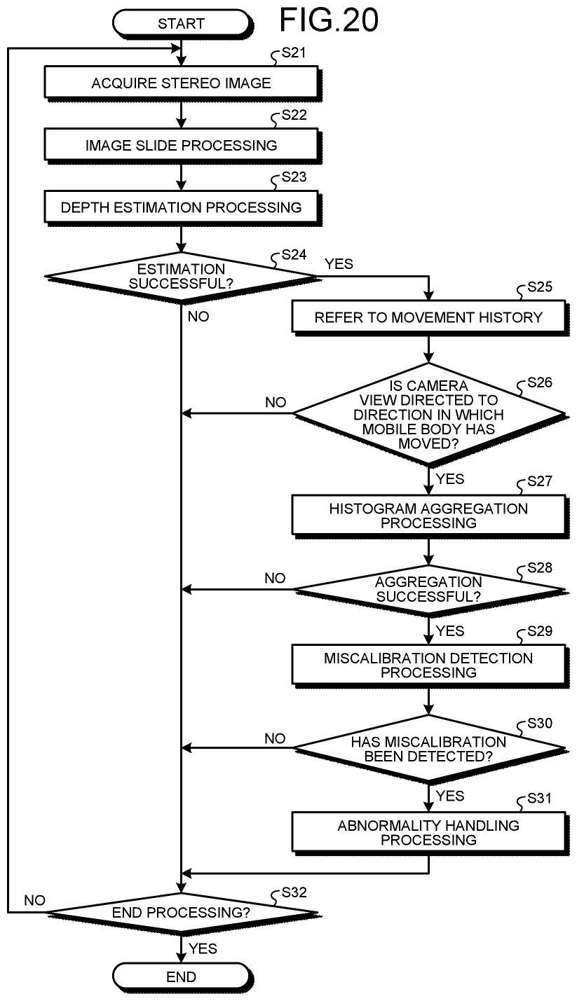

FIG. 20 is a diagram illustrating an example of information processing based on the movement history MH described with reference to FIGS. 14 and 18. Steps S21 to S24 and S29 to S32 are similar to steps S1 to S4 and S7 to S10 illustrated in FIG. 13. Therefore, differences from FIG. 13 will be mainly described.

In a case where it is determined in step S24 that the depth has been successfully estimated (step S24: Yes), the processing proceeds to step S25. In step S25, the subject area extraction unit 31 refers to the movement history MH of the mobile body 3 generated by the SLAM. In step S26, the subject area extraction unit 31 determines whether the stereo camera 20 being used or available has a visual field in the direction in which the mobile body 3 has moved so far.

In step S26, in a case where there is the stereo camera 20 having the visual field FV in the direction in which the mobile body 3 has moved (step S26: Yes), the processing proceeds to step S27. In step S27, the subject area extraction unit 31 extracts, as the subject area SUA, an area including an image of the stereo camera 20 having the visual field FV in the direction in which the mobile body 3 has moved. The depth estimation unit 12 generates a parallax map PM of the subject area SUA. The parallax histogram aggregation unit 13 generates a histogram HG of the parallax PR on the basis of the parallax map PM of the subject area SUA.

In step S28, the parallax histogram aggregation unit 13 determines whether or not the histogram HG has been aggregated. For example, the parallax histogram aggregation unit 13 acquires information regarding the search result of the corresponding point CP in the subject area SUA from the depth estimation unit 12. As described above, the depth estimation unit 12 uses stereo matching to search for the corresponding point CP between the slide image SLI and the second viewpoint image VPI2. The depth estimation unit 12 determines that the parallax PR has been successfully detected when the corresponding point CP exists in the search area SA, and determines that the parallax PR has not been successfully detected when the corresponding point CP does not exist in the search area SA.

When information indicating successful search of the corresponding point CP is acquired from the depth estimation unit 12, the parallax histogram aggregation unit 13 determines that the histogram HG has been successfully aggregated. When the parallax histogram aggregation unit 13 acquires information indicating failure of the search for the corresponding point CP from the depth estimation unit 12, it is determined that the histogram HG has not been successfully aggregated.

In a case where it is determined in step S28 that the histogram HG has been successfully aggregated (step S28: Yes), the processing proceeds to step S29. In step S29, the miscalibration detection unit 14 performs miscalibration detection processing. The subsequent processing (S29 to S32) is similar to the processing (S7 to S10) in FIG. 13.

### [4-3. Information Processing Method 2]

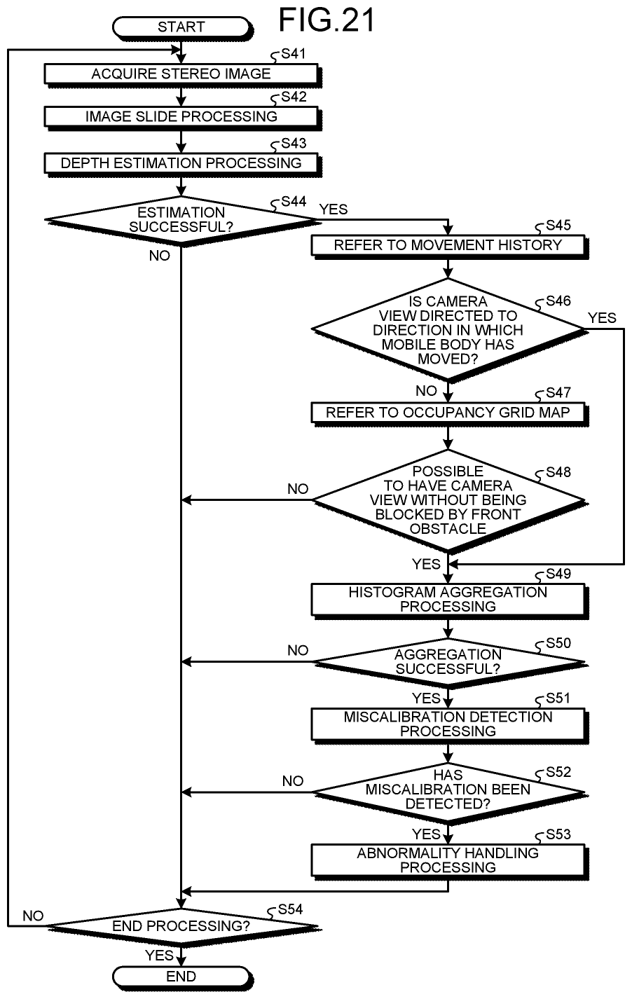

FIG. 21 is a diagram illustrating an example of information processing based on the environmental map OGM described with reference to FIGS. 16 and 19. Steps S41 to S46 and S49 to S54 are similar to steps S21 to S32 illustrated in FIG. 20. Therefore, differences from FIG. 20 will be mainly described.

In step S46, in a case where there is the stereo camera 20 (rear camera) having the visual field FV in the direction in which the mobile body 4 has moved (step S46: Yes), the processing proceeds to step S49. In step S49, the subject area extraction unit 41 extracts an area including an image of the rear camera as the subject area SUA.

In step S46, in a case where there is the stereo camera 20 (non-rear camera) having the visual field FV in a direction other than the direction in which the mobile body 4 has moved (step S46: No), the processing proceeds to step S47. In step S47, the subject area extraction unit 41 generates an occupancy grid map, for example, as the environmental map OGM. In step S48, the subject area extraction unit 41 determines whether it is possible to have a view of the non-rear camera without being blocked by the object OT on the basis of the environmental map OGM and the position information of the mobile body 3. The state in which the view is blocked represents a state of low visibility for distant locations because of the object OT.

In a case where it is determined in step S48 that it is possible to have a view of the non-rear camera without being blocked by the object OT (step S48: Yes), the processing proceeds to step S49. In step S49, the subject area extraction unit 41 extracts an area including an image of the non-rear camera as the subject area SUA. With this configuration, among the images in all directions captured by the plurality of stereo cameras 20, an area including the image of the rear camera and the image of the non-rear camera having the visual field FV in the direction having few objects OT blocking the visual field is extracted as the subject area SUA. The depth estimation unit 12 generates a parallax map PM of the subject area SUA. The parallax histogram aggregation unit 13 generates a histogram HG of the parallax PR on the basis of the parallax map PM of the subject area SUA.

In step S50, the parallax histogram aggregation unit 13 determines whether the histogram HG has been successfully aggregated. For example, the parallax histogram aggregation unit 13 acquires information regarding the search result of the corresponding point CP in the subject area SUA from the depth estimation unit 12. As described above, the depth estimation unit 12 uses stereo matching to search for the corresponding point CP between the slide image SLI and the second viewpoint image VPI2. The depth estimation unit 12 determines that the parallax PR has been successfully detected when the corresponding point CP exists in the search area SA, and determines that the parallax PR has not been successfully detected when the corresponding point CP does not exist in the search area SA.

When information indicating successful search of the corresponding point CP is acquired from the depth estimation unit 12, the parallax histogram aggregation unit 13 determines that the histogram HG has been successfully aggregated. When the parallax histogram aggregation unit 13 acquires information indicating failure of the search for the corresponding point CP from the depth estimation unit 12, it is determined that the histogram HG has not been successfully aggregated.

In a case where it is determined in step S50 that the histogram HG has been successfully aggregated (step S50: Yes), the processing proceeds to step S551. In step S51, the miscalibration detection unit 14 performs miscalibration detection processing. The subsequent processing (S52 to S54) is similar to the processing (S30 to S32) in FIG. 20.

### [4-4. Effects]

Also in the present embodiment, the histogram HG is selectively generated for the specific subject area SUA extracted from the stereo image STI. This reduces the load of calculation at the time of generating the histogram HG. Since the histogram of the area other than the subject area SUA is not included as the noise component, making it possible to suppress erroneous determination.

### 5. Abnormality Handling Processing

As described above, the post-stage module 15 performs the abnormality handling processing on the basis of the detection information CDI indicating occurrence of miscalibration. The post-stage module 15 includes various configurations according to the type of the abnormality handling processing, such as a notification unit 151, an operation control unit 152, and a calibration unit 153. Hereinafter, these configurations will be described.

### [5-1. Restriction of Moving Speed]

FIG. 22 is a diagram illustrating an example in which a moving speed is restricted as abnormality handling processing.

The horizontal axis in FIG. 22 indicates a real distance between the mobile body and the obstacle. The vertical axis in FIG. 2 indicates an estimated distance between the mobile body and the obstacle estimated by the depth estimation unit 12. When the distance between the mobile body and the obstacle is long, accurate distance measurement cannot be performed, and thus the depth is not estimated. When the mobile body approaches the obstacle with a certain distance (32 m in the example of FIG. 22), the depth estimation is enabled.

The occurrence of miscalibration results in discrepancy in the distance to the obstacle. In the example of FIG. 22, the estimated distance is 58 m despite the real distance of 32 m. The moving speed of the mobile body is restricted to a speed at which an obstacle can be avoided with a margin even in an unexpected situation. When the distance to the obstacle is estimated to be shorter than the real distance due to miscalibration, the moving speed would not decrease when approaching the obstacle, leading to a possibility of a failure in avoiding the obstacle. To handle this, when the detection information CDI is acquired, the operation control unit 152 sets the moving speed to be lower than the set speed which is set before acquisition of the detection information CDI.

For example, the moving speed that has been set on the basis of the estimated distance to the obstacle estimated without considering the miscalibration and set before acquisition of the detection information CDI is defined as a first set speed. When having detected the occurrence of miscalibration based on the detection information CDI, the operation control unit 152 switches the moving speed immediately after the acquisition of the detection information CDI to a second set speed, which is lower than the first set speed. In the example of FIG. 22, the detection information CDI is output when the vehicle approaches the obstacle at a distance of 20 m. The operation control unit 152 decreases the moving speed in response to the acquisition of the detection information CDI. This activates braking before the vehicle approaches the obstacle too close. Since the moving speed to the obstacle is reduced, it is easy to avoid the obstacle when approaching the obstacle.

### [5-2. Notification to User]

FIG. 23 is a diagram illustrating an example in which notification to the user is performed as the abnormality handling processing.

When the detection information CDI is acquired, the notification unit 151 notifies the user of occurrence of miscalibration. In the example of FIG. 23, a warning message NM is displayed in a message field MF of a proportional control system PCS. The proportional control system PCS displays a camera indicator CI corresponding to each stereo camera 20. The notification unit 151 turns on the camera indicator CI corresponding to the stereo camera 20 in which the miscalibration has occurred. This leads to notification of which stereo camera 20 has the occurrence of miscalibration. With such a notification, it is possible to prompt the user to take an appropriate action when the miscalibration occurs.

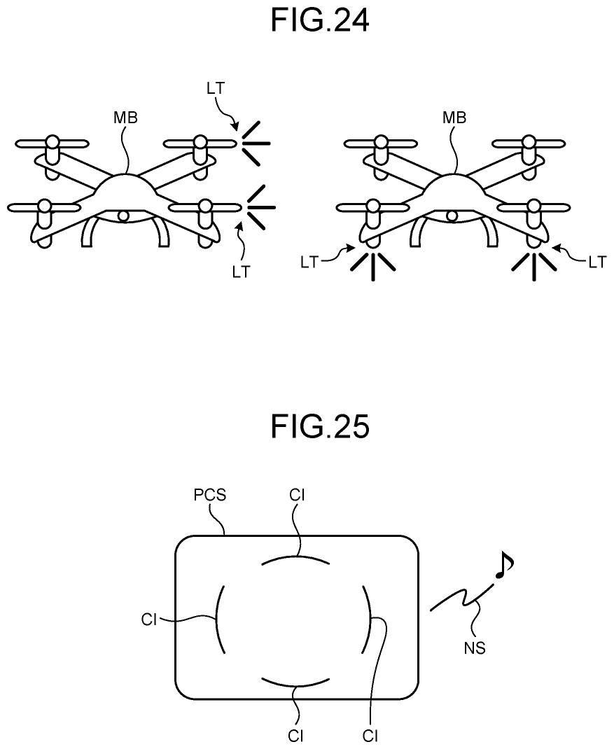

FIGS. 24 and 25 are diagrams illustrating another example of notification.

In the example of FIG. 24, the mobile body MB is equipped with a light LT for notifying miscalibration. The light LT is installed for each stereo camera 20. Turning on the light LT corresponding to the stereo camera 20 in which the miscalibration has occurred will lead to notification of which stereo camera 20 has the occurrence of miscalibration. In the example of FIG. 25, a notification sound NS is output by a speaker built in the proportional control system PCS. The user can recognize the occurrence of miscalibration by the notification sound NS.

### [5-3. Automatic Calibration]

The calibration unit 153 performs calibration of the stereo camera 20 in response to detection of miscalibration. Calibration is automatically performed by an internal mechanism of the mobile body (automatic calibration). According to this configuration, it is possible to stably perform the movement while automatically canceling the miscalibration.

### [5-4. Depth Correction]

As illustrated in FIG. 11, when the miscalibration occurs, the distribution of the parallax PR is shifted as a whole. With the knowledge of the shift amount, the depth can be corrected. For example, when the stereo image STI includes a distant area where the parallax PR can be regarded as 0, the depth estimation unit 12 compares the lower boundary value Bmin of the parallax PR of the distant area with the slide amount SLA. In the case of no occurrence of miscalibration, the lower boundary value Bmin matches the slide amount SLA. In the case of having a difference between the lower boundary value Bmin and the slide amount SLA, the difference is considered to be caused by miscalibration. Therefore, the depth estimation unit 12 estimates the difference between the lower boundary value Bmin and the slide amount SLA as the shift amount caused by the miscalibration.

When miscalibration occurs, the image slide unit 11 generates a corrected image by sliding the first viewpoint image VPI1 in the parallax direction by the above-described shift amount (difference between the lower boundary value Bmin and the slide amount SLA). The depth estimation unit 12 estimates the depth on the basis of the second viewpoint image VPI2 and the corrected image. With this configuration, the movement can be stably performed while the miscalibration is canceled in software.

### 6. Hardware Configuration Example

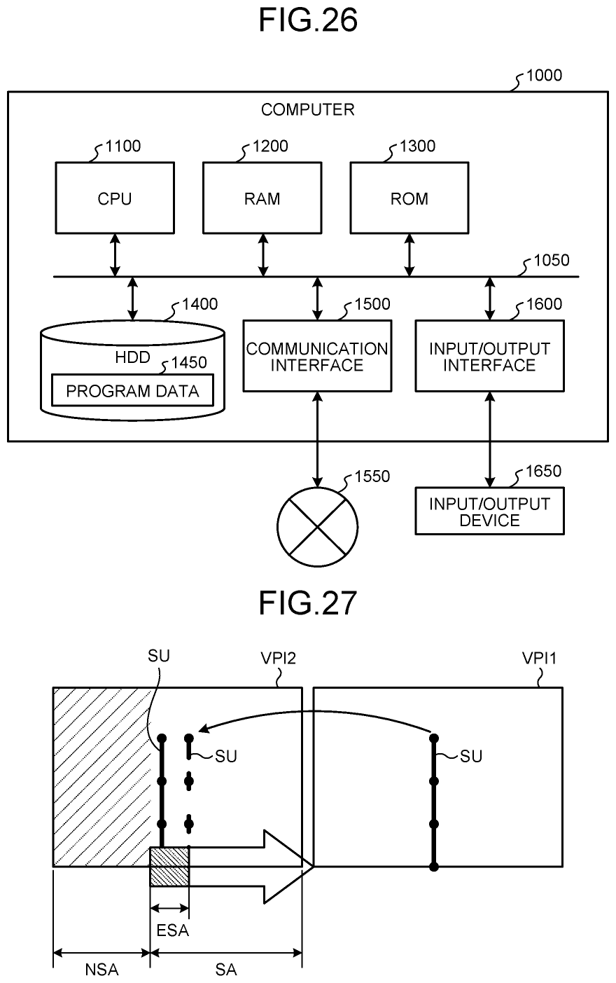

FIG. 26 is a diagram illustrating a hardware configuration example of the processing devices 10, 30, and 40.

The processing devices 10, 30, and 40 are implemented by a computer 1000 having a configuration as illustrated in FIG. 26, for example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates on the basis of a program stored in the ROM 1300 or the HDD 1400 so as to control each of components. For example, the CPU 1100 develops a program stored in the ROM 1300 or the HDD 1400 onto the RAM 1200, and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that performs non-transitory recording of a program executed by the CPU 1100, data used by the program, or the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on a predetermined recording medium. Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the processing device 10, 30, or 40, the CPU 1100 of the computer 1000 executes the information processing program loaded on the RAM 1200 so as to implement the functions of the processing device 10, 30, or 40. The HDD 1400 also stores data such as an information processing program according to the present disclosure and topographical information acquired from the topographical information database 52. While the CPU 1100 executes program data 1450 read from the HDD 1400, the CPU 1100 may acquire these programs from another device via the external network 1550, as another example.

### 7. Modification

FIG. 27 is a diagram illustrating another example for avoiding the second influence of the miscalibration described above.

As illustrated in FIG. 8, when the miscalibration occurs, the corresponding point CP of the second viewpoint image VPI2 is located in the non-search area NSA, leading to a possibility of a failure in the search for the corresponding point CP. In the method of FIG. 9, the search area SA is expanded in the parallax direction by the slide amount SLA using the slide image SLI. The method of expanding the search area SA is not limited thereto.

For example, in the example of FIG. 27, the subject SU captured in the first viewpoint image VPI1 is directly projected onto the second viewpoint image VPI2 without sliding. However, the corresponding point CP is searched from a position shifted leftward from the position of the subject SU appearing in the first viewpoint image VPI1. With this implementation, the search area SA expands in the left direction by a width ESA. When the subject SU appearing in the second viewpoint image VPI2 is included in the expanded area of the width ESA, the corresponding point CP can be searched for while the parallax PR has a negative value.

The effects described in the present specification are merely examples, and thus, there may be other effects, not limited to the exemplified effects.

[Supplementary Notes]

Note that the present technique can also have the following configurations.

(1)

A mobile body comprising:
an image slide unit that generates a slide image by sliding a first viewpoint image in a parallax direction;
a parallax histogram aggregation unit that generates a parallax histogram from the slide image and a second viewpoint image; and
a miscalibration detection unit that determines an occurrence of miscalibration when a lower boundary value of the parallax in the histogram is smaller than a slide amount of the first viewpoint image.
   (2)

The mobile body according to (1), further comprising:
a notification unit that notifies a user of the occurrence of the miscalibration.
   (3)

The mobile body according to (1) or (2), further comprising:
an operation control unit that controls a moving speed at the occurrence of the miscalibration to be lower than a moving speed set on the basis of an estimated distance to an obstacle which is estimated without considering the miscalibration.
   (4)

The mobile body according to any one of (1) to (3), further comprising:
a calibration unit that performs calibration in response to the detection of the miscalibration.
   (5)

The mobile body according to any one of (1) to (3), further comprising:
a depth estimation unit that estimates, at the occurrence of the miscalibration, a depth on the basis of the second viewpoint image and a corrected image obtained by sliding the first viewpoint image in the parallax direction by a difference between the lower boundary value and the slide amount.
   (6)

The mobile body according to any one of (1) to (5), further comprising:
a subject area extraction unit that extracts a subject area in which the parallax is predictable,
wherein the parallax histogram aggregation unit selectively generates the histogram for the subject area.
   (7)

The mobile body according to (6),
wherein the subject area extraction unit extracts a sky area as the subject area using a semantic segmentation method.
   (8)

The mobile body according to (6),
wherein the subject area extraction unit extracts an area including a horizon as the subject area on the basis of altitude and geographical information regarding the mobile body.
   (9)

The mobile body according to (6),
wherein the subject area extraction unit determines a direction in which the mobile body has moved on the basis of a movement history of the mobile body, and extracts an area including an image in the direction in which the mobile body has moved, as the subject area.
   (10)

The mobile body according to (6),
wherein the subject area extraction unit determines a direction having few objects blocking a view on the basis of an environmental map and position information of the mobile body, and extracts an area including an image in a direction having few objects, as the subject area.
   (11)

An information processing method to be executed by a computer, the method comprising:
generating a slide image by sliding a first viewpoint image in a parallax direction;
generating a parallax histogram from the slide image and a second viewpoint image; and
determining an occurrence of miscalibration when a lower boundary value of the parallax in the histogram is smaller than a slide amount of the first viewpoint image.
   (12)

A program causing a computer to execute processing comprising:
generating a slide image by sliding a first viewpoint image in a parallax direction;
generating a parallax histogram from the slide image and a second viewpoint image; and
determining an occurrence of miscalibration when a lower boundary value of the parallax in the histogram is smaller than a slide amount of the first viewpoint image.

### REFERENCE SIGNS LIST

1, 2, 3 MOBILE BODY
11 IMAGE SLIDE UNIT
12 DEPTH ESTIMATION UNIT
13 PARALLAX HISTOGRAM AGGREGATION UNIT
14 MISCALIBRATION DETECTION UNIT
20 STEREO CAMERA
31, 41 SUBJECT AREA EXTRACTION UNIT
151 NOTIFICATION UNIT
152 OPERATION CONTROL UNIT
153 CALIBRATION UNIT
Bmin LOWER BOUNDARY VALUE
FV VISUAL FIELD
HG HISTOGRAM
HZ HORIZON
MH MOVEMENT HISTORY
OGM ENVIRONMENTAL MAP
OT OBJECT BLOCKING VIEW
PR PARALLAX
SLA SLIDE AMOUNT
SLI SLIDE IMAGE
SUA SUBJECT AREA
VPI1 FIRST VIEWPOINT IMAGE
VPI2 SECOND VIEWPOINT IMAGE

1. A mobile body comprising:
an image slide unit that generates a slide image by sliding a first viewpoint image in a parallax direction;
a parallax histogram aggregation unit that generates a parallax histogram from the slide image and a second viewpoint image; and
a miscalibration detection unit that determines an occurrence of miscalibration when a lower boundary value of the parallax in the histogram is smaller than a slide amount of the first viewpoint image.

2. The mobile body according to claim 1, further comprising:
a notification unit that notifies a user of the occurrence of the miscalibration.

3. The mobile body according to claim 1, further comprising:
an operation control unit that controls a moving speed at the occurrence of the miscalibration to be lower than a moving speed set on the basis of an estimated distance to an obstacle which is estimated without considering the miscalibration.

4. The mobile body according to claim 1, further comprising:
a calibration unit that performs calibration in response to the detection of the miscalibration.

5. The mobile body according to claim 1, further comprising:
a depth estimation unit that estimates, at the occurrence of the miscalibration, a depth on the basis of the second viewpoint image and a corrected image obtained by sliding the first viewpoint image in the parallax direction by a difference between the lower boundary value and the slide amount.

6. The mobile body according to claim 1, further comprising:
a subject area extraction unit that extracts a subject area in which the parallax is predictable,
wherein the parallax histogram aggregation unit selectively generates the histogram for the subject area.

7. The mobile body according to claim 6,
wherein the subject area extraction unit extracts a sky area as the subject area using a semantic segmentation method.

8. The mobile body according to claim 6,
wherein the subject area extraction unit extracts an area including a horizon as the subject area on the basis of altitude and geographical information regarding the mobile body.

9. The mobile body according to claim 6,
wherein the subject area extraction unit determines a direction in which the mobile body has moved on the basis of a movement history of the mobile body, and extracts an area including an image in the direction in which the mobile body has moved, as the subject area.

10. The mobile body according to claim 6,
wherein the subject area extraction unit determines a direction having few objects blocking a view on the basis of an environmental map and position information of the mobile body, and extracts an area including an image in a direction having few objects, as the subject area.

11. An information processing method to be executed by a computer, the method comprising:
generating a slide image by sliding a first viewpoint image in a parallax direction;
generating a parallax histogram from the slide image and a second viewpoint image; and
determining an occurrence of miscalibration when a lower boundary value of the parallax in the histogram is smaller than a slide amount of the first viewpoint image.

12. A program causing a computer to execute processing comprising:
generating a slide image by sliding a first viewpoint image in a parallax direction;
generating a parallax histogram from the slide image and a second viewpoint image; and
determining an occurrence of miscalibration when a lower boundary value of the parallax in the histogram is smaller than a slide amount of the first viewpoint image.
